(19) United States
(12) Patent Application Publication
(10) Pub. No.: US 2021/0082649 A1
(43) Pub. Date: Mar. 18, 2021

(54) ELECTROMAGNETIC RELAY

(71) Applicant: OMRON Corporation, Kyoto-shi (JP)

(72) Inventors: Kohei OTSUKA, Omuta-shi (JP); Ryota MINOWA, Yamaga-shi (JP); Hiroyuki IWASAKA, Kamimashiki-gun (JP); Hiroyuki HARIMOCHI, Kumamoto-shi (JP); Shinichi OGAWA, Kikuchi-shi (JP); Naoki KAWAGUCHI, Yame-shi (JP)

(73) Assignee: OMRON Corporation

(21) Appl. No.: 17/012,068

(22) Filed: Sep. 4, 2020

(30) Foreign Application Priority Data
Sep. 13, 2019 (JP) 2019-167287

(51) Int. Cl. H01H 50/18; H01H 50/14; H01H 50/54; H01H 50/64; H01H 50/36

(52) U.S. Cl. CPC H01H 50/18; H01H 50/14; H01H 50/36; H01H 50/641; H01H 50/546

(57) ABSTRACT

A pair of fixed terminals each include a first plate portion and a fixed contact arranged on the first plate portion. A movable contact piece includes a pair of movable contacts arranged to face the fixed contact. An accommodating portion includes a plurality of wall portions extending in a moving direction of the movable contact piece and an accommodating space that is surrounded by the plurality of wall portions and accommodates the fixed contact and the movable contact piece. The first plate portion protrudes from one of the plurality of wall portions to an outside of the accommodating space. At least one magnet is arranged to face a wall portion different from the wall portion from which the first plate portion protrudes among the plurality of wall portions.

### CROSS-REFERENCE TO RELATED APPLICATION

This application claims priority to Japanese Patent Application No. 2019-167287, filed Sep. 13, 2019. The contents of that application are incorporated by reference herein in their entirety.

### FIELD

The present invention relates to an electromagnetic relay.

### BACKGROUND

Conventionally, an electromagnetic relay that opens and closes an electric circuit is known. The electromagnetic relay described in Japanese Laid-Open Patent Publication No. 2019-083175 is a plunger-type electromagnetic relay in which fixed terminal including fixed contact is a plate shape terminal. The fixed terminal protrudes from a housing in a longitudinal direction of the movable contact piece. Further, a pair of permanent magnets is arranged in an accommodating portion in which the movable contact piece is housed so as to sandwich the movable contact piece in the longitudinal direction. As a result, the Lorentz force acts on an arc generated at the contact, and the arc is elongated in the accommodating portion.

### SUMMARY

In order to secure the Lorentz force necessary for extending the arc, it is preferable that the magnetic flux density is uniform in the accommodating portion. For example, at a position away from the pair of magnets, the magnetic flux density becomes smaller than at a position close to the pair of magnets, so it is difficult to secure a sufficient Lorentz force for extending the arc. Particularly, when the plate shape fixed terminal extends in the longitudinal direction of the movable contact piece and the pair of permanent magnets is arranged to face each other in the longitudinal direction, a space for disposing the pair of permanent magnets may be limited by the fixed terminal, and it may not be possible to secure the sufficient Lorentz force. In this case, it is conceivable to secure the space for disposing the pair of magnets by forming the fixed terminal into an L shape as in Japanese Laid-Open Patent Publication No. 2019-083175, but there is a risk that the configuration of the electromagnetic relay will be complicated.

An object of the present invention is to provide an electromagnetic relay with a simple configuration in which a magnetic flux density is easily generated uniformly in a space in which a movable contact piece is housed, in the electromagnetic relay having a plate shape fixed terminal.

An electromagnetic relay according to one aspect of the present invention includes a pair of fixed terminals, a movable contact piece, a drive shaft, a drive device, an accommodating portion, and at least one magnet. The pair of fixed terminals have a plate shape. The pair of fixed terminals each include a first plate portion and a fixed contact. The movable contact piece includes a pair of movable contacts arranged to face the fixed contact. The movable contact piece is configured to move in a moving direction including a contact direction in which the pair of movable contacts comes into contact with the fixed contact and a separation direction in which the pair of movable contacts separates from the fixed contact. The drive shaft is coupled to the movable contact piece. The drive device is configured to move the movable contact piece through the drive shaft. The accommodating portion includes a plurality of wall portions extending in the moving direction of the movable contact piece and an accommodating space that is surrounded by the plurality of wall portions and accommodates the fixed contact and the movable contact piece. The at least one magnet is configured to generate a magnetic field in the accommodating space. The first plate portion protrudes from one of the plurality of wall portions to an outside of the accommodating space. The at least one magnet is arranged to face a wall portion different from the wall portion from which the first plate portion protrudes among the plurality of wall portions.

In this electromagnetic relay, the at least one magnet is arranged to face the wall portion different from the wall portion from which the first plate portion of the pair of fixed terminals protrudes. Therefore, a space for disposing the at least one magnet is less likely to be limited by the pair of fixed terminals. This makes it possible to easily arrange the at least one magnet so that a magnetic flux density can be easily generated uniformly in the accommodating space. As a result, an electromagnetic relay that facilitates uniform generation of the magnetic flux density in the accommodating space can be provided with a simple configuration.

The first plate portion may protrude from a wall portion located in a longitudinal direction of the movable contact piece among the plurality of wall portions to the outside of the accommodating space. The at least one magnet may be arranged to face a wall portion located in a lateral direction of the movable contact piece among the plurality of wall portions and to overlap at least a moving range of the pair of movable contacts as viewed from the lateral direction of the movable contact piece. In this case, the space for disposing the at least one magnet is less likely to be limited by the pair of fixed terminals.

The first plate portion may include an inner portion arranged in the accommodating space. The entire inner portion may overlap the at least one magnet as viewed from the lateral direction. In this case, the magnetic flux density is easily generated uniformly in the accommodating space.

The at least one magnet may include a first magnet and a second magnet. The first magnet and the second magnet may be arranged so as to sandwich the movable contact piece in the lateral direction. In this case, an electromagnetic relay that facilitates uniform generation of the magnetic flux density in the accommodating space can be provided with a simple configuration.

The first plate portion may protrude from a wall portion located in a lateral direction of the movable contact piece among the plurality of wall portions to an outside of the accommodating space. The at least one magnet may be arranged to face a wall portion located in a longitudinal direction of the movable contact piece among the plurality of wall portions and to overlap at least a moving range of the pair of movable contacts as viewed from the longitudinal direction of the movable contact piece. In this case, the space for disposing the at least one magnet is less likely to be limited by the pair of fixed terminals.

The first plate portion may include an inner portion arranged in the accommodating space. The entire inner portion may overlap the at least one magnet as viewed from the longitudinal direction. In this case, the magnetic flux density is easily generated uniformly in the accommodating space.

The at least one magnet may include a first magnet and a second magnet. The first magnet and the second magnet may be arranged so as to sandwich the movable contact piece in the longitudinal direction. In this case, an electromagnetic relay that facilitates uniform generation of the magnetic flux density in the accommodating space can be provided with a simple configuration.

Each of the pair of fixed terminals may further include a second plate portion that is connected to the first plate portion and extends in the moving direction of the movable contact piece outside the accommodating space. In this case, in an electromagnetic relay using a pair of fixed terminals extending in the moving direction, magnetic flux density is easily generated uniformly in the accommodating space.

Each of the pair of fixed terminals may further include a third plate portion that extends in a protruding direction of the first plate portion and is connected to the second plate portion.

The movable contact piece may further include a first surface on which the pair of movable contacts is arranged and a second surface opposite to the first surface. The at least one magnet may extend in the separation direction beyond the second surface of the movable contact piece. In this case, the magnetic flux density is more easily generated uniformly in the accommodating space.

The first plate portion may include a first surface on which the fixed contact is arranged and a second surface opposite to the first surface of the first plate portion. The at least one magnet may extend in the contact direction beyond the second surface of the first plate portion. In this case, the magnetic flux density is more easily generated uniformly in the accommodating space.

The electromagnetic relay may further include a yoke connected to the at least one magnet. In this case, it is possible to easily adjust the magnetic flux and suppress the leakage of the magnetic flux to the outside.

### BRIEF DESCRIPTION OF THE DRAWINGS

FIG. 1 is a schematic cross-sectional view of an electromagnetic relay when the electromagnetic relay is in an open state.

FIG. 2 is a schematic cross-sectional view of the electromagnetic relay when the electromagnetic relay is in a closed state.

FIG. 3 is a schematic view of an accommodating space as viewed from above.

FIG. 4 is a schematic view of the accommodating space as viewed from the front.

FIG. 5 is a schematic view of the accommodating space of the electromagnetic relay according to a modification as viewed from above.

FIG. 6 is a schematic view of the accommodating space of the electromagnetic relay according to a modification as viewed from above.

FIG. 7 is a schematic view of the accommodating space of the electromagnetic relay according to a modification as viewed from the front.

FIG. 8 is a schematic view of the accommodating space of the electromagnetic relay according to a modification as viewed from above.

FIG. 9 is a schematic view of the accommodating space of the electromagnetic relay according to a modification as viewed from above.

FIG. 10 is a schematic view of the accommodating space of the electromagnetic relay according to a modification as viewed from above.

FIG. 11 is a schematic view of the accommodating space of the electromagnetic relay according to a modification as viewed from the front.

FIG. 12 is a schematic view of the accommodating space of the electromagnetic relay according to a modification as viewed from the front.

FIG. 13 is a schematic view of the accommodating space of the electromagnetic relay according to a modification as viewed from above.

FIG. 14 is a schematic view of the accommodating space of the electromagnetic relay according to a modification as viewed from the front.

FIG. 15 is a schematic view of the accommodating space of the electromagnetic relay according to a modification as viewed from the front.

FIG. 16 is a schematic view of the accommodating space of the electromagnetic relay according to a modification as viewed from the front.

FIG. 17 is a schematic view of the accommodating space of the electromagnetic relay according to a modification as viewed from the front.

FIG. 18 is a schematic view of the accommodating space of the electromagnetic relay according to a modification as viewed from the front.

FIG. 19 is a schematic view of the accommodating space of the electromagnetic relay according to a modification as viewed from above.

FIG. 20 is a schematic view of the accommodating space of the electromagnetic relay according to a modification as viewed from the front.

FIG. 21 is a schematic view of the accommodating space of the electromagnetic relay according to a modification as viewed from above.

### DETAILED DESCRIPTION

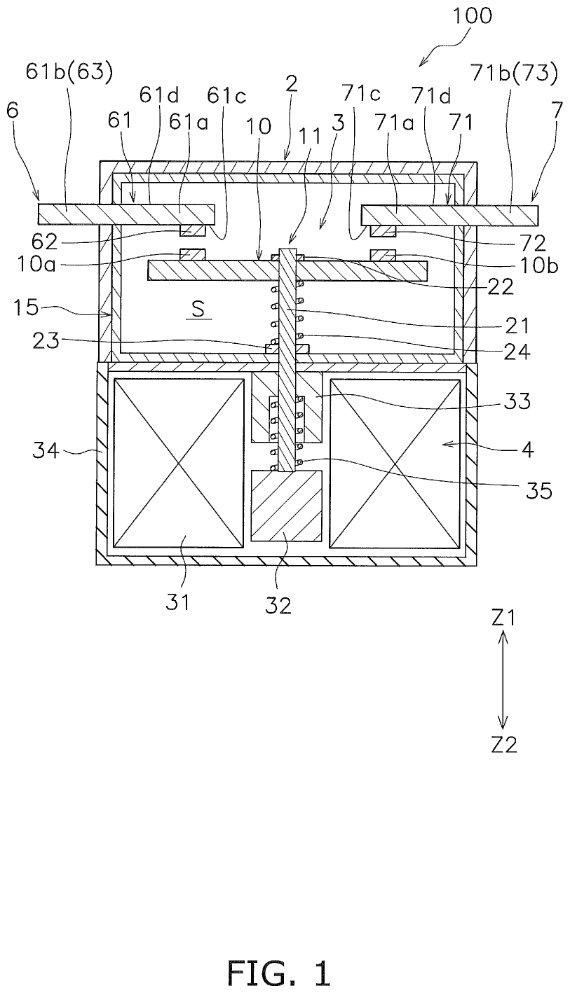

Hereinafter, embodiment of an electromagnetic relay 100 according to one aspect of the present invention will be described with reference to the drawings. Hereinafter, an example of the relay according to the embodiment will be described with reference to the drawings. When referring to the drawings, an upper side in FIG. 1 is referred to as “up”, a lower side is referred to as “down”, a left side is referred to as “left”, and a right side is referred to as “right” in order to facilitate understanding of the description. Further, a front side of the paper surface of FIG. 1 is referred to as “front”, and back side of the paper surface of FIG. 1 is referred to as “back”. These directions are defined for convenience of explanation, and do not limit an arrangement direction of the electromagnetic relay 100.

FIG. 1 is a schematic cross-sectional view of the electromagnetic relay 100. As illustrated in FIG. 1, the electromagnetic relay 100 includes a housing 2, a contact device 3, a drive device 4, and at least one magnet 5.

The housing 2 has a substantially rectangular box shape and is made of an insulating material. A contact case 15 is arranged inside the housing 2. The contact case 15 is an example of an accommodating portion. The contact case 15 includes a plurality of wall portions 15a to 15d and an accommodating space S.

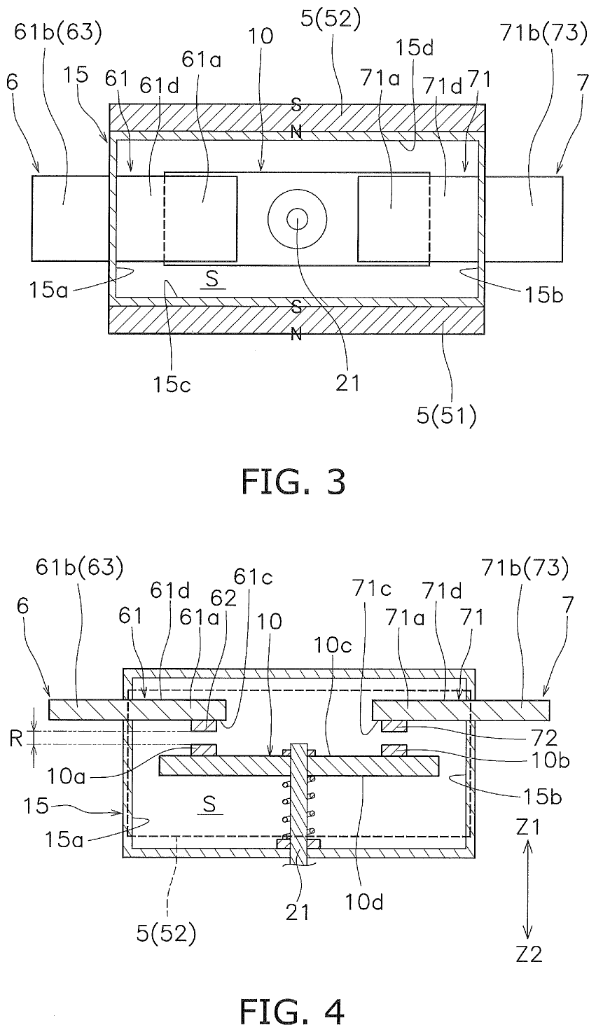

FIG. 3 is a schematic view of the accommodating space S as viewed from above. In FIG. 3, the housing 2 is omitted. FIG. 4 is a schematic view of the accommodating space S as viewed from the front. The plurality of wall portions 15a to 15d extend in a moving direction of a movable contact piece 10 described later. In this case, the plurality of wall portions 15a to 15d extend in an up-down direction. The wall portion 15a and the wall portion 15b are arranged to face each other in a left-right direction. The wall portion 15c and the wall portion 15d are arranged to face each other in a front-back direction. The contact device 3 is accommodated in the accommodating space S.

The contact device 3 includes a first fixed terminal 6, a second fixed terminal 7, a movable contact piece 10, and a movable mechanism 11. The first fixed terminal 6 and the second fixed terminal 7 are an example of a pair of fixed terminals.

The first fixed terminal 6 and the second fixed terminal 7 are plate-shaped terminals and extend in the left-right direction. The first fixed terminal 6 and the second fixed terminal 7 are arranged apart from each other in the left-right direction. The first fixed terminal 6 and the second fixed terminal 7 are made of a conductive material.

The first fixed terminal 6 includes a first plate portion 61, a fixed contact 62, and an external connection portion 63. The first plate portion 61 protrudes outside of the accommodating space S from one of the plurality of the wall portions 15a to 15d. The first plate portion 61 protrudes the wall portion 15a from the accommodating space S to the outside in a longitudinal direction (leftward) of the movable contact piece 10 as viewed from a lateral direction (the front-back direction) of the movable contact piece 10. The outside in the longitudinal direction means a direction away from a described later drive shaft 21 in the longitudinal direction of the movable contact piece 10.

The first plate portion 61 includes an inner portion 61a arranged inside the accommodating space S and an outer portion 61b arranged outside the accommodating space S. The inner portion 61a is arranged in the accommodating space S. The outer portion 61b is connected to the inner portion 61a and is integrated with the inner portion 61a. The outer portion 61b protrudes from the accommodating space S to the outside in the longitudinal direction of the movable contact piece 10 as viewed from the lateral direction of the movable contact piece 10. In this embodiment, the outer portion 61b protrudes outside of the accommodating space S from the wall portion 15a located in the longitudinal direction of the movable contact piece 10. The outer portion 61b penetrates the wall portion 15a in the left-right direction and protrudes leftward from the housing 2 to be exposed to the outside.

The first plate portion 61 includes a first surface 61c and a second surface 61d. The first surface 61c is a surface facing downward of the first plate portion 61. The second surface 61d is a surface opposite to the first surface 61c, and is a surface facing upward in the first plate portion 61.

The fixed contact 62 is arranged on the first plate portion 61. Specifically, the fixed contact 62 is arranged on the first surface 61c of the inner portion 61a of the first plate portion 61. The fixed contact 62 is made of a conductive material. The fixed contact 62 is provided separately from the first fixed terminal 6. The fixed contact 62 may be integrated with the first fixed terminal 6.

The external connection portion 63 protrudes leftward from the housing 2 and is exposed to the outside. The external connection portion 63 in this present embodiment is configured by the outer portion 61b of the first plate portion 61.

The second fixed terminal 7 includes a first plate portion 71, a fixed contact 72, and an external connection portion 73. The first plate portion 71 includes an inner portion 71a and an outer portion 71b. The outer portion 71b protrudes outside the accommodating space S from the wall portion 15b located in the longitudinal direction of the movable contact piece 10. The outer portion 71b penetrates the wall portion 15b in the left-right direction, and protrudes rightward from the housing 2 to be exposed to the outside. The first plate portion 71 includes a first surface 71c and a second surface 71d. Since the second fixed terminal 7 has a bilaterally symmetrical shape with the first fixed terminal 6 across the drive shaft 21, detailed description of each of these configurations will be omitted.

The movable contact piece 10 is a plate shape member that is long in one direction, and extends in the left-right direction inside the housing 2. In this embodiment, the longitudinal direction of the movable contact piece 10 matches the left-right direction. Moreover, the lateral direction of the movable contact piece 10 matches the front-back direction. The movable contact piece 10 is made of a conductive material.

The movable contact piece 10 includes movable contacts 10a, 10b. The movable contacts 10a, 10b are an example of a pair of movable contacts. The movable contact 10a is arranged at a position facing the fixed contact 62 and can contact the fixed contact 62. The movable contact 10b is arranged at a distance in the left-right direction from the movable contact 10a. The movable contact 10b is arranged at a position facing the fixed contact 72 and can contact the fixed contact 72. The movable contacts 10a, 10b are made of a conductive material. The movable contacts 10a, 10b are provided separately from the movable contact piece 10. Note that, the movable contacts 10a, 10b may be integrated with the movable contact piece 10.

The movable contact piece 10 is configured to move in the moving direction including a contact direction Z1 in which the movable contacts 10a, 10b contact the fixed contacts 62, 72 and a separation direction Z2 in which the movable contacts 10a, 10b separate from the fixed contacts 62, 72. The contact direction Z1 is the upper side in FIG. 1. The separation direction Z2 is the lower side in FIG. 1. Therefore, the contact direction Z1 and the separation direction Z2 are parallel to the up-down direction. The contact direction Z1 and the separation direction Z2 are examples of moving direction of the movable contact piece 10.

The movable mechanism 11 supports the movable contact piece 10. The movable mechanism 11 is provided so as to be movable to a closed position where the fixed contacts 62, 72 and the movable contacts 10a, 10b contact each other, and an open position where the fixed contacts 62, 72 and the movable contacts 10a, 10b separate from each other.

That is, the movable mechanism 11 is provided so as to be movable in the contact direction Z1 and the separation direction Z2.

The movable mechanism 11 includes the drive shaft 21, a first holding member 22, a second holding member 23, and a contact spring 24. The drive shaft 21 is coupled to the movable contact piece 10. The drive shaft 21 extends in the up-down direction and penetrates the movable contact piece 10 in the up-down direction. The drive shaft 21 is provided so as to be movable in the contact direction Z1 and the separation direction Z2.

The first holding member 22 is fixed to the drive shaft 21 on the contact direction Z1 side beyond the movable contact piece 10. The first holding member 22 can contact the movable contact piece 10. The second holding member 23 is fixed to the drive shaft 21 on the separation direction Z2 side beyond the movable contact piece 10. The contact spring 24 is arranged between the movable contact piece 10 and the second holding member 23. The contact spring 24 biases the movable contact piece 10 in the contact direction Z1 through the second holding member 23.

The drive device 4 moves the movable mechanism 11 between the closed position and the open position by an electromagnetic force. The drive device 4 moves the movable contact piece 10 in the contact direction Z1 and the separation direction Z2 through the drive shaft 21. The drive device 4 includes a coil 31, a movable iron core 32, a fixed core 33, a yoke 34, and a return spring 35.

When a voltage is applied and the coil 31 is excited, the coil 31 generates the electromagnetic force that moves the movable iron core 32 in the contact direction Z1. The movable iron core 32 is coupled to the drive shaft 21 so as to be integrally movable. The fixed core 33 is arranged at a position facing the movable iron core 32. The yoke 34 is arranged so as to surround the coil 31. The return spring 35 is arranged between the movable iron core 32 and the fixed core 33. The return spring 35 biases the movable iron core 32 in the separation direction Z2.

FIG. 1 shows a state in which the drive device 4 is not excited. When the drive device 4 is not excited, the movable mechanism 11 is in the open position. Therefore, the movable contacts 10a, 10b are separated from the fixed contacts 62, 72. When the drive device 4 is not excited, the movable contact piece 10 is pressed in the separation direction Z2 through the movable mechanism 11.

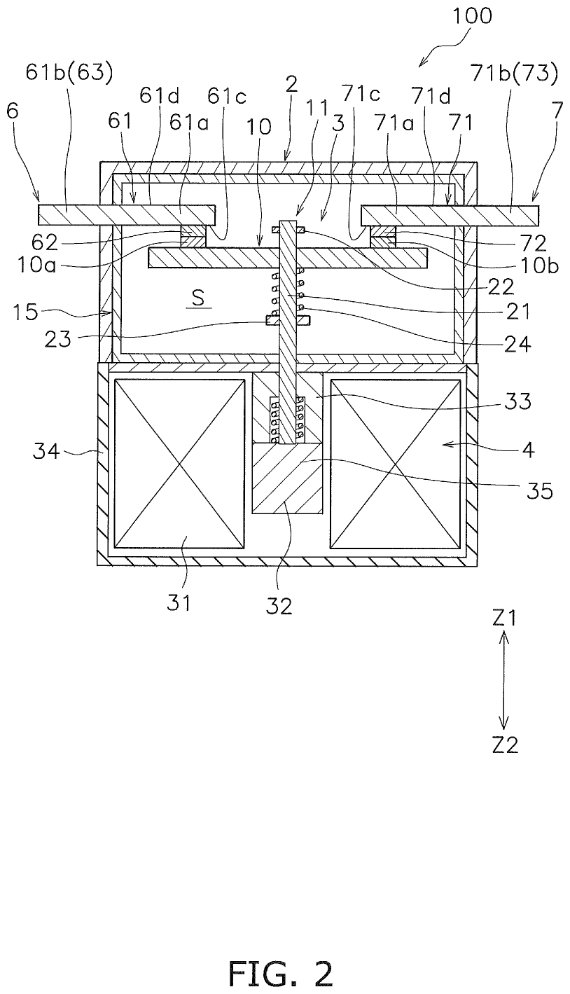

FIG. 2 shows a state in which the drive device 4 is excited and the movable mechanism 11 moves to the closed position. When the drive device 4 is excited, the movable iron core 32 moves in the contact direction Z1 together with the drive shaft 21.

With the movement of the drive shaft 21 in the contact direction Z1, the contact spring 24 is compressed by the second holding member 23. As a result, the force pressing the movable contact piece 10 in the contact direction Z1 increases, the movable contact piece 10 moves in the contact direction Z1, and the movable contacts 10a, 10b contact the fixed contacts 62, 72.

As illustrated in FIGS. 3 and 4, the at least one magnet 5 is arranged around the contact case 15 and generates a magnetic field in the accommodating space S. The at least one magnet 5 is supported by the contact case 15, for example. The at least one magnet 5 is arranged to face the wall portions 15c, 15d different from the wall portions 15a, 15b from which the first plate portions 61, 71 protrude among the plurality of wall portions 15a to 15d. The at least one magnet 5 is arranged outside in the lateral direction of the movable contact piece 10 beyond the first plate portions 61, 71. The at least one magnet 5 is arranged so as to overlap at least a moving range R of the movable contacts 10a, 10b as viewed from the lateral direction of the movable contact piece 10. The moving range R of the movable contact piece 10 is a moving range until the movable contacts 10a, 10b come into contact with the fixed contacts 62, 72, and is an area between the movable contacts 10a, 10b and the fixed contacts 62, 72 when the movable mechanism 11 is in the open position.

The at least one magnet 5 includes a magnet 51 and a magnet 52. The magnet 51 is an example of a first magnet, and the magnet 52 is an example of a second magnet.

The magnets 51, 52 are permanent magnets having rectangular parallelepiped shape. The magnets 51, 52 are arranged so as to sandwich the movable contact piece 10 in the lateral direction of the movable contact piece 10. Specifically, the magnet 51 is arranged in front of the contact case 15. The magnet 52 is arranged behind the contact case 15. The first magnet and the second magnet are arranged such that different poles face each other in the front-rear direction. The magnets 51 and 52 may be arranged so that the same poles face each other.

Both ends of the magnets 51, 52 in the left-right direction extend outside in the longitudinal direction of the movable contact piece 10 beyond the accommodating space S. As illustrated in FIG. 3, the movable contact piece 10 further includes a first surface 10c and a second surface 10d. The first surface 10c is a surface on the contact direction Z1 side of the movable contact piece 10 and a surface facing upward. The second surface 10d is a surface opposite to the first surface 10c. That is, the second surface 10d is a surface on the side in the separation direction Z2 of the movable contact piece 10 and is a surface facing downward. The magnets 51, 52 extend in the separation direction Z2 beyond the second surface 10d of the movable contact piece 10.

The magnets 51, 52 extend in the contact direction Z1 beyond the second surfaces 61d, 71d of the first plate portions 61, 71. As viewed from the lateral direction of the movable contact piece 10, the entire movable contact piece 10 and the entire inner portions 61a, 71a of the first plate portions 61, 71 overlap the magnets 51, 52. By arranging the magnets 51, 52 in this way, a magnetic flux density is easily generated uniformly in the accommodating space S.

In the electromagnetic relay 100 configured as described above, the at least one magnet 5 is arranged to face the wall portions 15c, 15d different from the wall portions 15a, 15b from which the first plate portions 61, 71 of the first fixed terminal 6 and the second fixed terminal 7 protrude. Therefore, a space for disposing the at least one magnet 5 is less likely to be limited by the first fixed terminal 6 and the second fixed terminal 7. This makes it possible to easily arrange the at least one magnet 5 so that the magnetic flux density can be easily generated uniformly in the accommodating space S. As a result, the electromagnetic relay that facilitates uniform generation of the magnetic flux density in the accommodating space S can be provided with a simple configuration. Further, since the at least one magnet 5 is arranged so as to overlap at least the moving range R of the movable contacts 10a, 10b as viewed from the lateral direction of the movable contact piece 10, it is easy to control the extension direction of an arc.

While the embodiment of the electromagnetic relay according to one aspect of the present invention has been described, the present invention should not be construed as being limited thereto, and various types of modifications may be made without departing from the spirit or scope of the general inventive concept of the invention.

The configuration of the at least one magnet 5 is not limited to the above embodiment. That is, the arrangement or shape of the at least one magnet 5 is not limited to the above embodiment. The arrangement of the at least one magnet 5 may be appropriately changed according to the configuration and shape of the electromagnetic relay. For example, the configuration of the at least one magnet 5 may change suitably according to the shape such as the accommodating space S, the first fixed terminal 6, the second fixed terminal 7, or the movable contact piece 10.

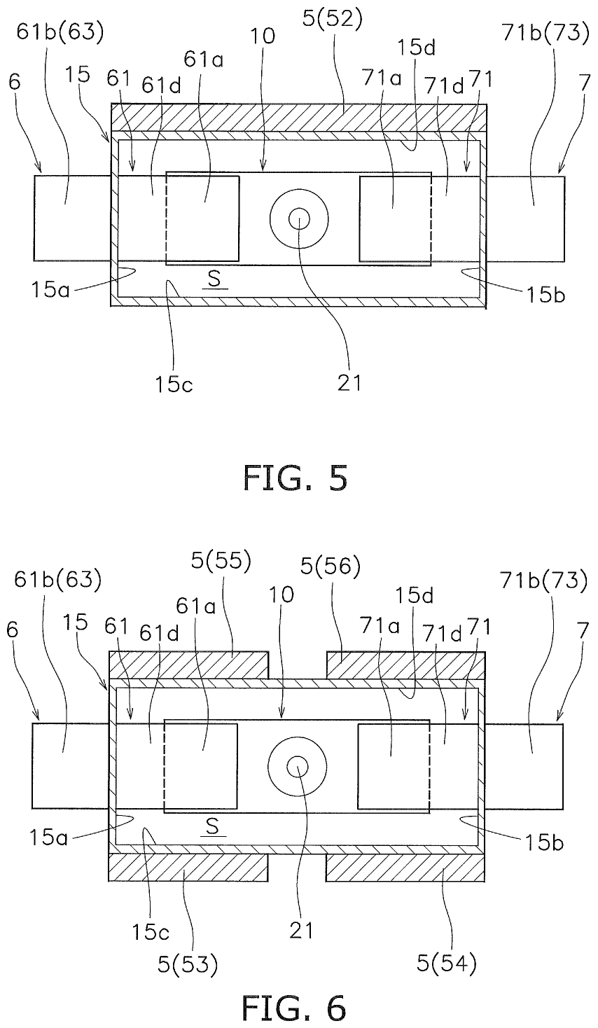

For example, as illustrated in FIG. 5, the at least one magnet 5 may be composed of one permanent magnet. For example, the at least one magnet 5 may include only one of the magnets 51, 52. FIG. 5 shows a configuration in which the at least one magnet 5 include only the magnet 52. Further, the at least one magnet may be arranged such that two permanent magnets are spaced from each other in the left-right direction or the up-down direction and face one of the wall portions 15c, 15d.

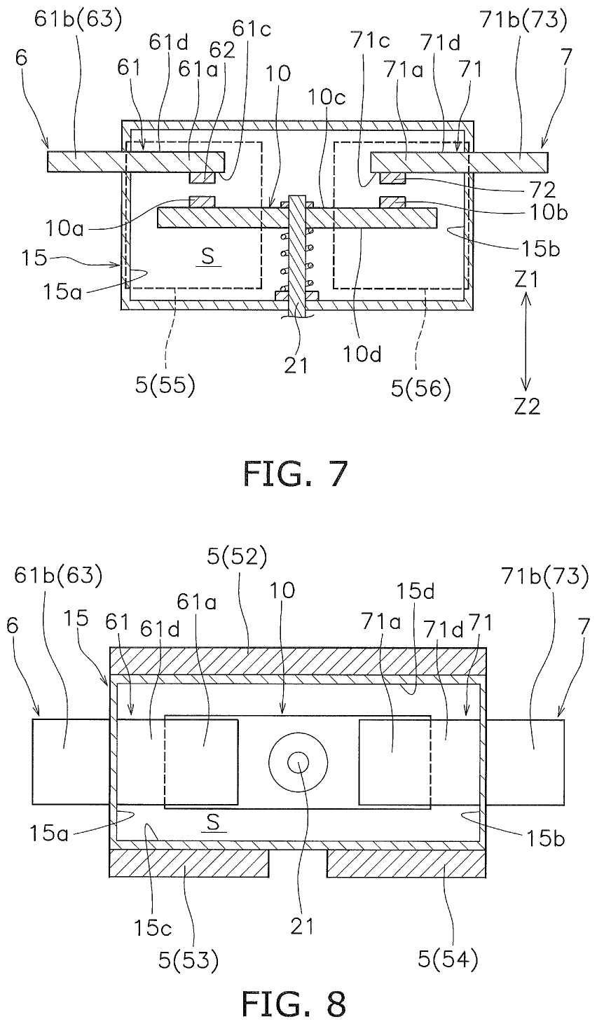

The at least one magnet 5 may include three or more permanent magnets. Specifically, as illustrated in FIGS. 6 and 7, the at least one magnet 5 may include magnets 53-56. The magnet 53 and the magnet 54 are arranged on the front side of the contact case 15 so as to be spaced apart from each other in the left-right direction. The magnets 55 and 56 are arranged on the back side of the contact case 15 so as to be spaced apart from each other in the left-right direction. The magnet 53 and the magnet 55 are arranged so as to face each other in the lateral direction on the left side beyond the drive shaft 21. The magnet 54 and the magnet 56 are arranged so as to face each other in the lateral direction on the right side beyond the drive shaft 21. The magnets 53-56 extend in the separation direction Z2 beyond the second surface 10d of the movable contact piece 10. The magnets 53, 55 extend in the contact direction Zlbeyond the second surfaces 61d, 71d of the first plate portions 61, 71.

As illustrated in FIG. 8, the at least one magnet 5 may be composed of, for example, three permanent magnets 52-54. That is, the number of the at least one magnet 5 arranged to face each other does not necessarily have the same number.

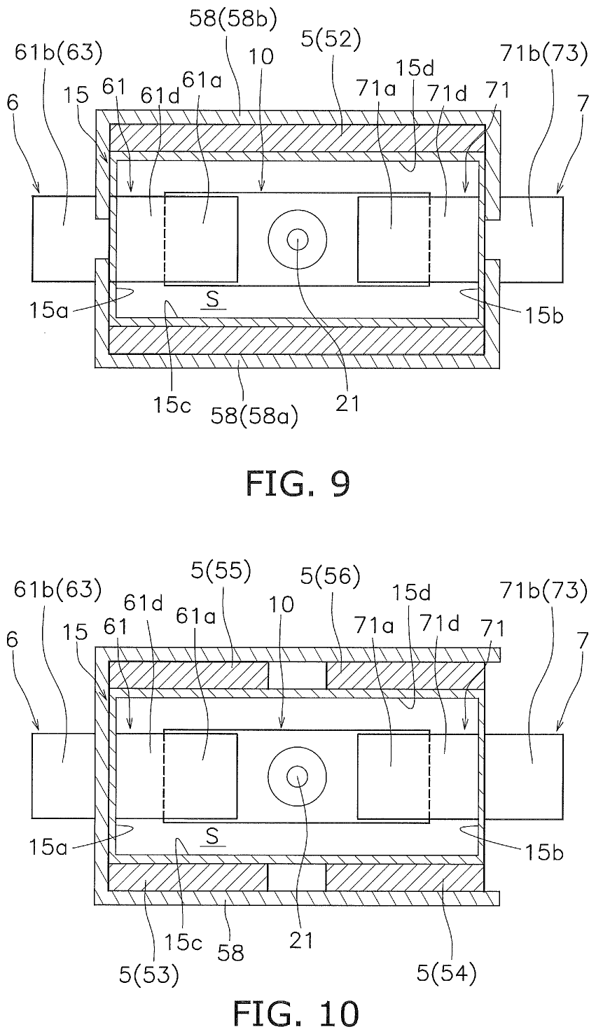

As illustrated in FIGS. 9 and 10, the electromagnetic relay 100 may further include a yoke 58 connected to at least one magnet 5. FIG. 9 shows a configuration in which the yoke 58 is connected to the magnets 51, 52. The yoke 58 includes a first yoke 58a and a second yoke 58b. The first yoke 58a is arranged so as to surround the magnet 51 from the outside. The second yoke 58b is arranged so as to surround the magnet 52 from the outside. Further, FIG. 10 shows a configuration in which the yoke 58 is connected to the magnets 53-56. The arrangement and shape of the yoke 58 may be appropriately changed according to the shape or arrangement of the at least one magnet 5.

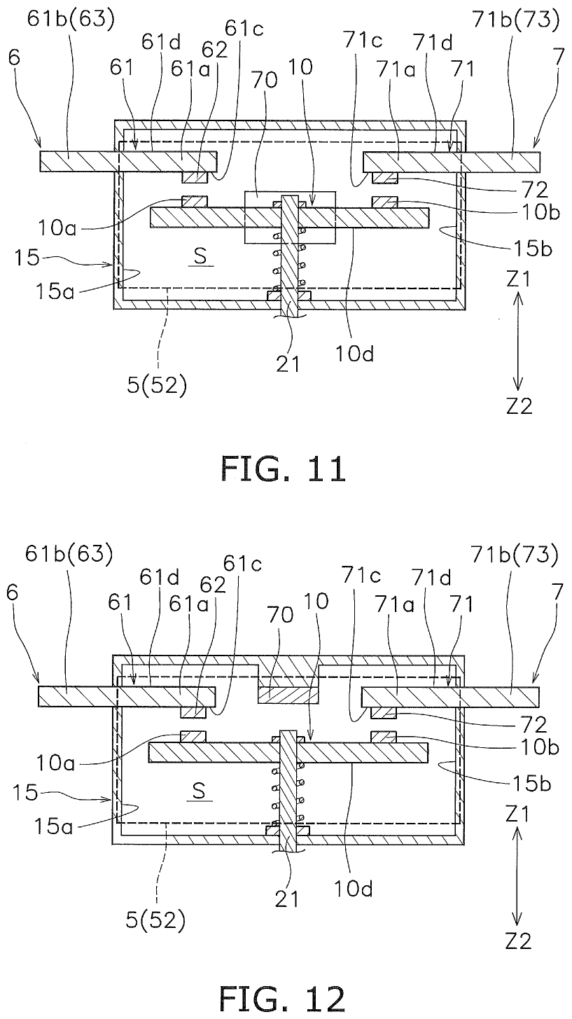

As illustrated in FIGS. 11 and 12, the electromagnetic relay 100 may further include a magnetic flux adjusting member 70 for adjusting the magnetic flux in the accommodating space S. The magnetic flux adjusting member 70 is arranged in the accommodating space S. The magnetic flux adjusting member 70 is made of a magnetic material. The magnetic flux adjusting member 70 may be arranged in a part of a member forming the accommodating space S and/or a member arranged inside the accommodating space S. As illustrated in FIG. 11, the magnetic flux adjusting member 70 may be arranged so as to sandwich the movable contact piece 10 near the drive shaft 21 in the accommodating space S. The magnetic flux adjusting member 70 may be supported by a member forming the accommodating space S and/or a part of a member arranged inside the accommodating space S. The magnetic flux adjusting member 70 may be supported by a part of the movable mechanism 11. For example, as illustrated in FIG. 12, the magnetic flux adjusting member 70 may be supported by the contact case 15.

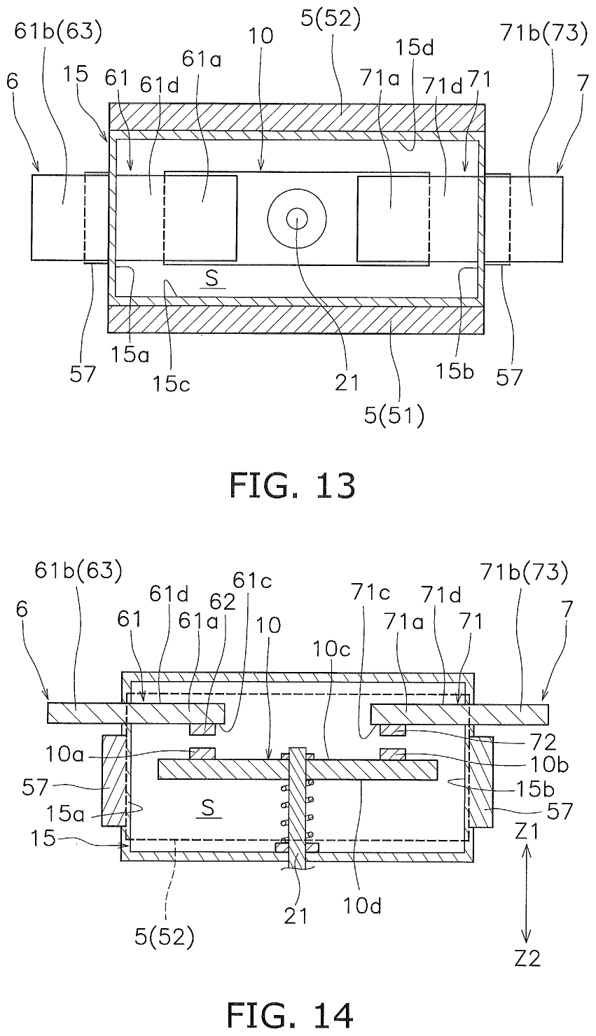

As illustrated in FIGS. 13 and 14, the at least one magnet 5 may include a pair of magnets 57 that is arranged to face each other in the longitudinal direction of the movable contact piece 10. The pair of magnets 57 is arranged so as to sandwich the movable contact piece 10 in the longitudinal direction of the movable contact piece 10. The pair of magnets 57 is arranged below the first fixed terminal 6 and the second fixed terminal 7.

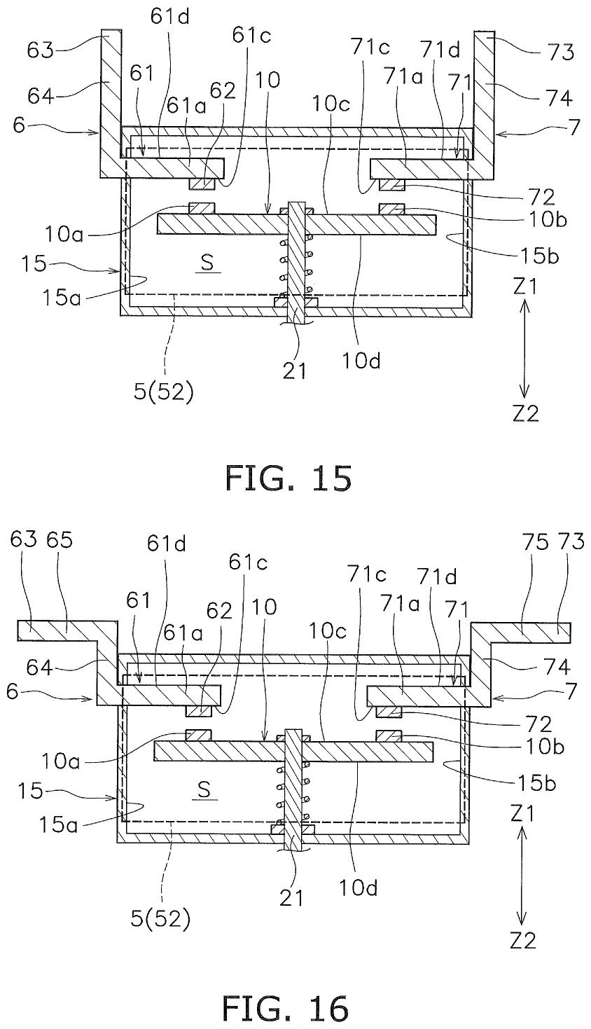

The shapes of the first fixed terminal 6 and the second fixed terminal 7 are not limited to those in the above embodiment. For example, as illustrated in FIG. 15, the first fixed terminal 6 and the second fixed terminal 7 may further include second plate portions 64, 74 extending in the moving direction of the movable contact piece 10. In this embodiment, the second plate portion 64 extends upward from the left end of the first plate portion 61. In this case, the first plate portion 61 may be arranged in the housing 2, the second plate portion 64 may be protruded upward from the housing 2, and the second plate portion 64 may be provided with the external connection portion 63. The second plate portion 74 has the same shape as the first plate portion 61.

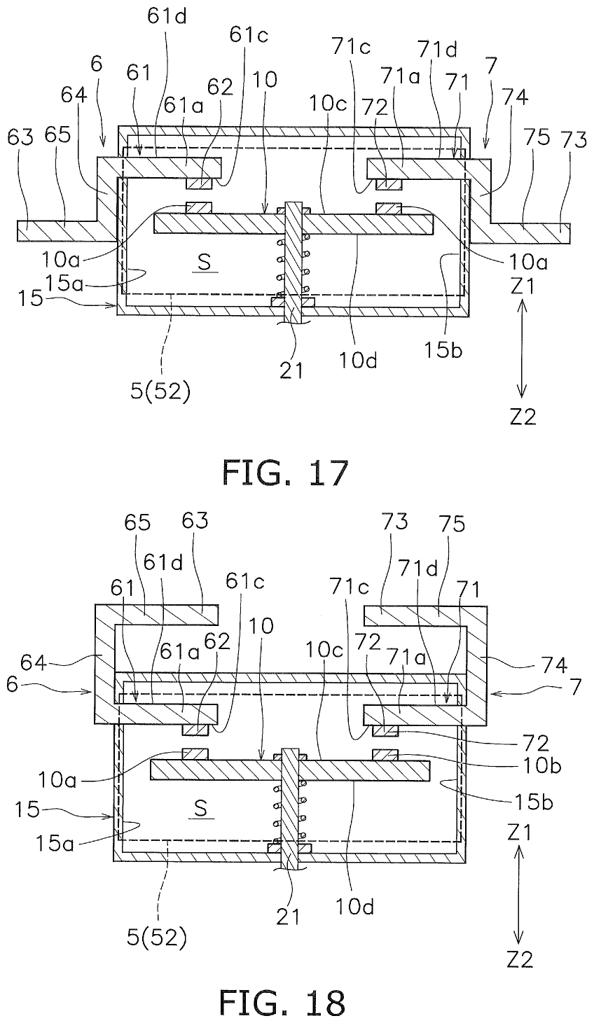

As illustrated in FIG. 16, the first fixed terminal 6 and the second fixed terminal 7 may further include third plate portions 65, 75 extending in the longitudinal direction of the movable contact piece 10. The third plate portion 65 is connected to the second plate portion 64. The third plate portion 65 extends in a protruding direction of the first plate portion 61. The third plate portion 65 extends from the upper end of the second plate portion 64 to the outside in the longitudinal direction. In this case, the third plate portion 65 may be protruded leftward from the housing 2, and the third plate portion 65 may be provided with the external connection portion 63. As illustrated in FIG. 17, the second plate portions 64, 74 may extend downward from the first plate portions 61, 71. The third plate portions 65 75 may extend in the longitudinal direction of the movable contact piece 10 from the lower ends of the second plate portions 64, 74.

As illustrated in FIG. 18, the third plate portions 65 and 75 may extend from the upper ends of the second plate portions 64, 74 to the inside in the longitudinal direction (direction toward the drive shaft 21). In this case, the first fixed terminal 6 and the second fixed terminal 7 are formed in a substantially C shape as viewed from the lateral direction of the movable contact piece 10.

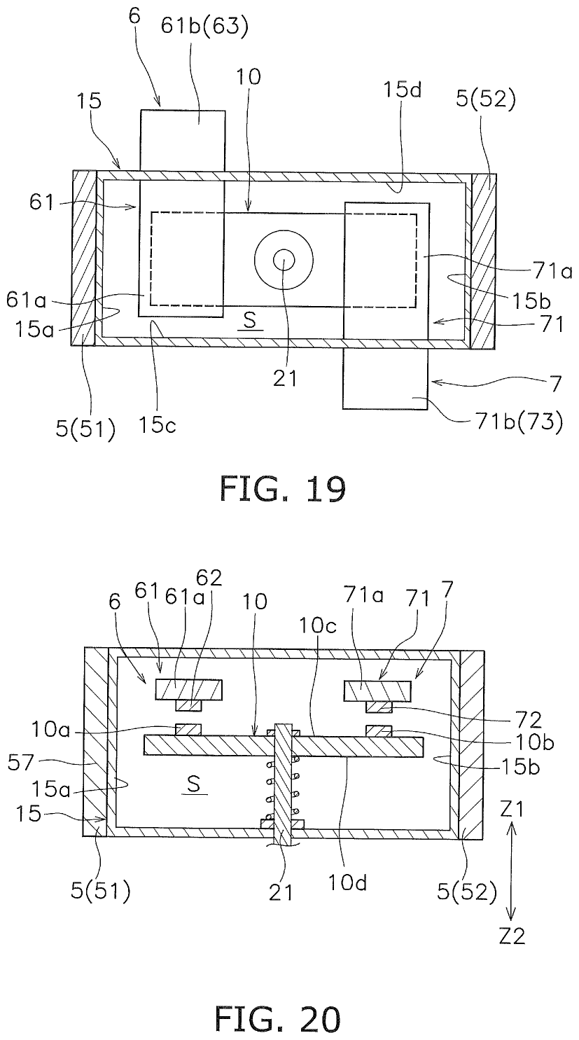

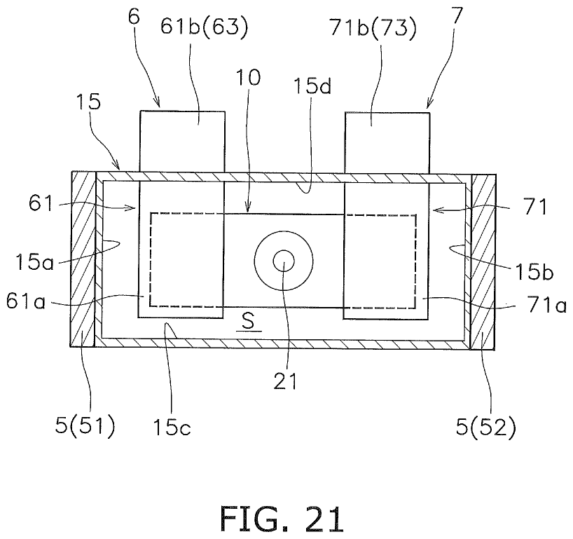

In the above-described embodiment, although the first fixed terminal 6 and the second fixed terminal 7 extend in the left-right direction, the first fixed terminal 6 and the second fixed terminal 7 may extend in the front-back direction. That is, as illustrated in FIG. 19, the first plate portions 61, 71 may protrude from the wall portions 15c, 15d located in the lateral direction of the movable contact piece 10 to the outside of the accommodating space S. In this case, as illustrated in FIGS. 13 and 14, the at least one magnet 5 is arranged so as to face the walls 15a, 15b located in the longitudinal direction of the movable contact piece 10. The wall portions from which the first plate portion 61 and the first plate portion 71 protrude may be different from each other as illustrated in FIG. 19, or may protrude from the same wall portion as illustrated in FIG. 21. For example, as illustrated in FIG. 19, the first plate portion 61 may protrude from the wall portion 15d and the first plate portion 71 may protrude from the wall portion 15c. For example, as illustrated in FIG. 21, the first plate portion 61 and the first plate portion 71 may protrude from the wall portion 15d.

In the above-described embodiment, the electromagnetic relay is configured to be pushed the movable contacts 10a, 10b toward the fixed contacts 62, 72, but the present invention may be applied to an electromagnetic relay configured to pull the movable contacts 10a, 10b into the fixed contacts 62, 72.

1. An electromagnetic relay comprising:
a pair of fixed terminals having a plate shape, the pair of fixed terminals each including a first plate portion and a fixed contact arranged on the first plate portion;
a movable contact piece including a pair of movable contacts arranged to face the fixed contact, the movable contact piece being configured to move in a moving direction including a contact direction in which the pair of movable contacts comes into contact with the fixed contact and a separation direction in which the pair of movable contacts separates from the fixed contact;
a drive shaft coupled to the movable contact piece;
a drive device configured to move the movable contact piece through the drive shaft;
an accommodating portion including a plurality of wall portions extending in the moving direction of the movable contact piece and an accommodating space that is surrounded by the plurality of wall portions and accommodates the fixed contact and the movable contact piece; and
at least one magnet configured to generate a magnetic field in the accommodating space, wherein
the first plate portion protrudes from one of the plurality of wall portions to an outside of the accommodating space, and
the at least one magnet is arranged to face a wall portion different from the wall portion from which the first plate portion protrudes among the plurality of wall portions.

2. The electromagnetic relay according to claim 1, wherein
the first plate portion protrudes from a wall portion located in a longitudinal direction of the movable contact piece among the plurality of wall portions to the outside of the accommodating space, and
the at least one magnet is arranged to face a wall portion located in a lateral direction of the movable contact piece among the plurality of wall portions and to overlap at least a moving range of the pair of movable contacts as viewed from the lateral direction of the movable contact piece.

3. The electromagnetic relay according to claim 2, wherein
the first plate portion includes an inner portion arranged in the accommodating space, and
the entire inner portion overlaps the at least one magnet as viewed from the lateral direction.

4. The electromagnetic relay according to claim 2, wherein
the at least one magnet includes a first magnet and a second magnet, and
the first magnet and the second magnet are arranged so as to sandwich the movable contact piece in the lateral direction.

5. The electromagnetic relay according to claim 1, wherein
the first plate portion protrudes from a wall portion located in a lateral direction of the movable contact piece among the plurality of wall portions to the outside of the accommodating space, and
the at least one magnet is arranged to face a wall portion located in a longitudinal direction of the movable contact piece among the plurality of wall portions and to overlap at least a moving range of the pair of movable contacts as viewed from the longitudinal direction of the movable contact piece.

6. The electromagnetic relay according to claim 5, wherein
the first plate portion includes an inner portion arranged in the accommodating space, and
the entire inner portion overlaps the at least one magnet as viewed from the longitudinal direction.

7. The electromagnetic relay according to claim 5, wherein
the at least one magnet include a first magnet and a second magnet, and
the first magnet and the second magnet are arranged so as to sandwich the movable contact piece in the longitudinal direction.

8. The electromagnetic relay according to claim 1, wherein
each of the pair of fixed terminals further includes a second plate portion that is connected to the first plate portion and extends in the moving direction of the movable contact piece outside the accommodating space.

9. The electromagnetic relay according to claim 8, wherein
each of the pair of fixed terminals further includes a third plate portion that extends in a protruding direction of the first plate portion and is connected to the second plate portion.

10. The electromagnetic relay according to claim 1, wherein
the movable contact piece further includes a first surface on which the pair of movable contacts is arranged and a second surface opposite to the first surface, and
the at least one magnet extends in the separation direction beyond the second surface of the movable contact piece.

11. The electromagnetic relay according to claim 1, wherein
the first plate portion includes a first surface on which the fixed contact is arranged and a second surface opposite to the first surface of the first plate portion, and
the at least one magnet extends in the contact direction beyond the second surface of the first plate portion.

12. The electromagnetic relay according to claim 1, further comprising:
a yoke connected to the at least one magnet.
